(19) United States
(12) Patent Application Publication
(10) Pub. No.: US 2002/0046802 A1
(43) Pub. Date: Apr. 25, 2002

(54) Method for manufacturing disposable worn article

(76) Inventors: Ikuo Tachibana, Hyogo (JP); Kiyofumi Inoue, Hyogo (JP); Yuzo Ichiura, Osaka (JP); Yoshinari Tanaka, Osaka (JP); Masaki Nakakado, Osaka (JP); Satoshi Tanaka, Osaka (JP)

Correspondence Address: Mark D. Saralino, Renner, Otto, Boisselle, & Sklar, L.L.P., 19th Floor, 1621 Euclid Avenue, Cleveland, OH, 44115, US

(21) Appl. No.: 09/891,034

(22) Filed: Jun. 25, 2001

(30) Foreign Application Priority Data
Aug. 4, 2000 (JP) 2000-237455

(51) Int. Cl. B31F 1/00

(52) U.S. Cl. 156/209; 156/321; 156/301

(57) ABSTRACT

A method for manufacturing a disposable worn article of the present invention includes: a first step of applying an adhesive on at least one of a first web and a second web; a second step of sandwiching an elastic member between the first and second webs and combining the first and second webs and the elastic member together, thereby producing a combined web; and a third step of melting a portion of at least one of the first and second webs and a portion of the elastic member, thereby reducing a shrinking force of the elastic member in the melted portion.

### BACKGROUND OF THE INVENTION

1. Field of the Invention

The present invention relates to a method for manufacturing a disposable worn article using an elastic sheet.

2. Description of the Related Art

Japanese Laid-Open Patent Publication No. 2000-26015 discloses a method for cutting off only an elastic member without damaging a base material sheet by using a roll cutter having a ridge-shaped blade thereon.

However, Laid-Open Patent Publication No. 2000-26015 fails to disclose sealing the base material sheet while cutting off the elastic member, improving the air permeability of the base material sheet while cutting off the elastic member, etc.

### SUMMARY OF THE INVENTION

A method for manufacturing a disposable worn article of the present invention includes: a first step of applying an adhesive on at least one of a first web and a second web; a second step of sandwiching an elastic member between the first and second webs and combining the first and second webs and the elastic member together, thereby producing a combined web; and a third step of melting a portion of at least one of the first and second webs and a portion of the elastic member, thereby reducing a shrinking force of the elastic member in the melted portion.

Another method for manufacturing a disposable worn article of the present invention includes: a first step of applying an adhesive on at least one of a first web and a second web; a second step of sandwiching an elastic member between the first and second webs and combining the first and second webs and the elastic member together, thereby producing a combined web; and a third step of melting a portion of at least one of the first and second webs and a portion of the elastic member, thereby cutting off the elastic member.

Still another method for manufacturing a disposable worn article includes: a first step of applying an adhesive on at least one of a first web and a second web; a second step of sandwiching an elastic member between the first and second webs and combining the first and second webs and the elastic member together, thereby producing a combined web; and a third step of cutting off a portion of at least one of the first and second webs, and the elastic member.

In one embodiment of the invention: the third step is performed by passing the combined web between an embossing roll having a plurality of protrusions and a counter roll; and an interval of the protrusions in a direction of a rotation axis of the embossing roll is about 1 mm to 25 mm.

In another embodiment of the invention, the third step is performed by passing the combined web between an embossing roll having a lattice portion and a counter roll.

In still another embodiment of the invention, a first charge is applied to an area of at least one of the first and second webs where the adhesive is to be applied, and a second charge different from the first charge is applied to the adhesive to be applied.

In still another embodiment of the invention: at least the first web includes a design area having at least one of a graphical design, a symbol and a character printed thereon; and the elastic member located on at least a portion of the design area is cut off in the third step.

In still another embodiment of the invention: at least the second web includes an area on which a member is to be adhered; and the elastic member located under at least a portion of the area is cut off in the third step.

In still another embodiment of the invention, the elastic member is at least one of a string rubber, a flat rubber and a meshed rubber.

### BRIEF DESCRIPTION OF THE DRAWINGS

FIG. 1 is a perspective view illustrating one embodiment of the method of the present invention.

Each of FIG. 2A, FIG. 2B and FIG. 2C is a diagram illustrating an example of a disposable worn article using a combined web.

Each of FIG. 3A and FIG. 3B is a diagram illustrating an example of a staggered emboss pattern.

FIG. 4 is a diagram illustrating how elastic members are cut off.

FIG. 5 is a diagram illustrating how elastic members are cut off.

FIG. 6 is a diagram illustrating an example of a lattice emboss pattern.

FIG. 7A is a diagram illustrating an example of an adhesive applicator, and each of FIG. 7B and FIG. 7C is a diagram illustrating an example of a conductive portion thereof.

### DESCRIPTION OF THE PREFERRED EMBODIMENTS

A first embodiment of the present invention will now be described with reference to the accompanying drawings.

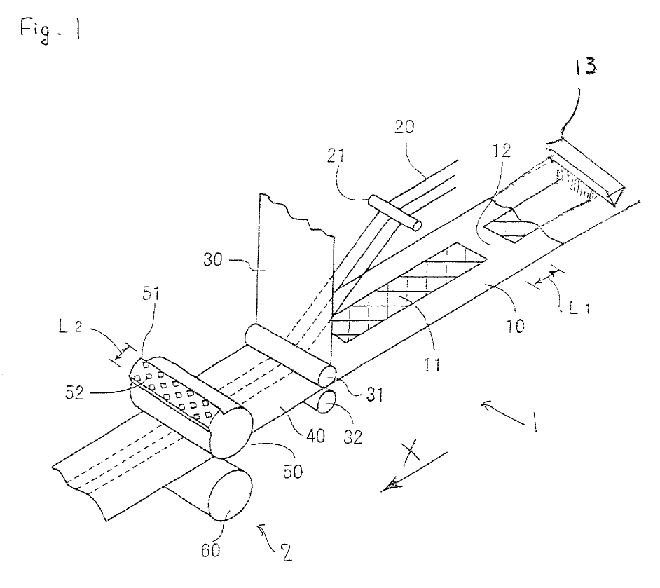

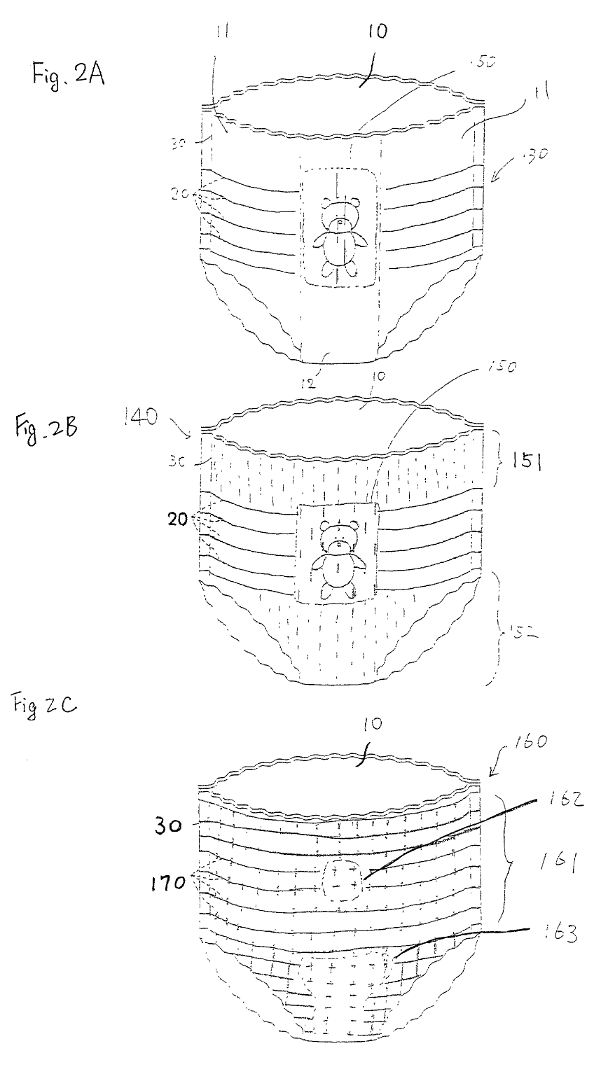

FIG. 1 is a diagram illustrating a manufacturing apparatus 1 for manufacturing a disposable worn article according to the first embodiment.

The manufacturing apparatus 1 includes an adhesive applicator 13 for applying an adhesive on a first sheet 10, a guide 21 for guiding an elastic member 20 between the first sheet 10 and a second sheet 30, press rolls 31 and 32 for pressing together the first sheet 10 and the second sheet 30 into a combined web 40, and a processing section 2 for cutting off at least a part of, or reducing the shrinking force of, the elastic member 20 of the combined web 40 produced through the press rolls 31 and 32. The adhesive may be applied on the second sheet 30.

The adhesive applicator 13 is capable of applying an adhesive on the first sheet 10, which has a strip shape of a predetermined width and which is advanced in the X direction (the direction of the production flow), so that an adhesive portion 11 and a non-adhesive portion 12 are provided on the first sheet 10. In terms of the air permeability of the combined web 40, it is preferred that the adhesive applicator 13 is a spray coater, a curtain coater, a spiral coater, or the like. The amount of adhesive is preferably about 1 g/m² to about 20 g/m². The adhesive may be a hot melt. A specific example of the adhesive applicator 13 will be described later.

The elastic member 20 under a predetermined tension is supplied to the guide 21. The elastic member 20 may be in the form of a plurality of lines, as illustrated in FIG. 1, or a mesh (e.g., elastomeric netting such as REBOUND^{(R)} of CONWED PLASTICS may be used). The elastic member 20 may be a string rubber or a flat rubber. The guide 21 is capable of reciprocating transversely of the direction of the production flow. In such a case, the guide 21 is capable of guiding the elastic member 20 between the first sheet 10 and the second sheet 30 so that the elastic member 20 is drawn in a non-linear line. A predetermined tension is applied to the elastic member 20 supplied to the guide 21 by means of a tension roll (not shown).

The processing section 2 includes an embossing roll 50 and a counter roll 60 facing the embossing roll 50. The combined web 40 is inserted between the embossing roll 50 and the counter roll 60, and the processing section 2 cuts off at least a part of, or reduces the shrinking force of, the elastic member 20. The embossing roll 50 includes an embossing section 51 having a plurality of protrusions. The protrusions may generate heat as will be described later. In such a case, the amount of heat to be generated is determined by the distance between the embossing roll 50 and the counter roll 60, the shape and/or the size of each protrusion, the material, the cross-sectional area and/or the shape of the elastic member 20, and/or the speed at which the combined web 40 is advanced.

FIG. 2A to FIG. 2C illustrate an exemplary disposable worn article made of the combined web 40, which has been passed through the processing section 2. The disposable worn article illustrated in FIG. 2A to FIG. 2C (e.g., disposable underpants or a disposable diaper; hereinafter referred to simply as “underpants”) includes a design area 150 having a graphical design or characters printed thereon. If the shrinking force of a part of the elastic member 20 on the design area 150 is not reduced or eliminated, the design area 150 will be wrinkled by the force, thereby deteriorating the appearance of the article.

Also in cases where a label having a graphical design or characters printed thereon is attached to the combined web 40, the label will have wrinkles due to the shrinkage of the elastic member 20, thereby deteriorating the appearance of the article. Besides, such wrinkles make it difficult to adhere, on the combined web 40, a member such as a label, a tape used for fixing a diaper, a tape used when disposing of the article having the combined web 40, etc. Even if such a member is successfully adhered on the combined web 40 while the wrinkles are being smoothed out, it is difficult to keep the adhesion between the combined web 40 and the member for a long period of time due to the shrinkage of the elastic member 20.

Underpants 130 include the adhesive portion 11, the non-adhesive portion 12 which has substantially the same width as that of the design area 150, and the part of the elastic member 20 on the design area 150 is cut off. The shrinkage of the cut elastic member 20 stops in the vicinity of the boundary between the adhesive portion 11 and the non-adhesive portion 12. Where the combined web 40 has the non-adhesive portion 12, it is preferred that the embossing section 51 has at least two rows of protrusions such that a portion of a protrusion in the first row overlaps a portion of a protrusion in the second row in the direction of the rotation axis of the embossing roll 50, in order to reduce or eliminate the shrinking force of the elastic member 20 on the design area 150. This is because it is not possible, with a single row of protrusions, to cut off a portion of the elastic member 20 located between adjacent protrusions. Even with a single row of protrusions, the elastic member 20 can be cut off if the protrusions are in a slant arrangement. Alternatively, for example, cutting off, etc., of a plurality of rubber strings can be achieved with a single protrusion. The length L₂ of the embossing section 51 may be slightly smaller than the length L₁ of the non-adhesive portion 12.

In underpants 140, an adhesive is applied also in the design area 150. In order to reduce or eliminate the shrinking force of the part of the elastic member 20 on the design area 150, it is preferred that the protrusions in each row are arranged at a predetermined interval in the embossing section 51 across the entirety of the design area 150. In other words, it is preferred that the protrusions have an overlap with one another as they are projected in the axial direction of the embossing roll 50.

While the elastic member 20 exists under the sheet, the processing section 2 may be used to reduce or eliminate the shrinking force of the elastic member 20 in advance in cases where an additional member (e.g., a tape used when disposing of the underpants or a tape to be attached to a diaper body or a label) is adhered on the sheet. This is because it is difficult to fix such an additional member on the sheet while the elastic member 20 is shrunk.

Underpants 160 are made of a combined web having a meshed elastic member 170 sandwiched between the first and second sheets at a predetermined tension. In a waist area 161, the vertical elastics are cut off while leaving the horizontal elastics (the elastic around the waist) so that the underpants 160 fit well to the body. Note however that the vertical and horizontal elastics are both cut off in an area 162 where an additional member or a label is adhered. Moreover, the vertical and horizontal elastics are both cut off in a predetermined area 163. The predetermined area 163 is an area where it is preferred that the underpants 160 do not shrink. An absorber may be provided in the area.

As described above, it is made possible to adhere a member on the combined web 40 by reducing the shrinking force of the elastic member 20 of the combined web 40 in areas where the member is to be adhered. Possible methods for reducing or eliminating the shrinking force of the elastic member 20 include: cutting off the elastic member 20; reducing the shrinking force of the elastic member 20; altering the molecular structure of the elastic member 20 (when the elastic member 20 is a rubber), and melting a part of the combined web 40 and curing the melted part.

The protrusions may generate heat in order to reduce or eliminate the shrinking force of the elastic member. In such a case, the elastic member 20 is cut off by the protrusions melting at least a part of the second sheet 30 and at least a part of the elastic member 20. In this process, the first sheet and the second sheet are sealed together. For example, in the case of the underpants 130, the first sheet and the second sheet are sealed together while the elastic member 20 is cut off. The wrinkling of the elastic member 20 is improved when the shrinking force of the elastic member 20 is reduced, even if the elastic member 20 is not cut off.

Moreover, even if the protrusions do not generate heat, it is possible to cut off the elastic member 20 via the second sheet 30 when the width of each protrusion is small (e.g., several microns to about 0.5 mm). In this process, at least apart of the second sheet 30 is cut by the protrusions, thereby increasing the air permeability of the underpants 140. In addition to the design area 150, a part of the elastic member 20 corresponding to an upper waist area 151 and/or a leg area 152 of the underpants 140 may also be opened by the protrusions.

The protrusions of the embossing section 51 will now be described. FIG. 3A illustrates an emboss pattern including a plurality of rectangular protrusions arranged in a staggered pattern. The embossing section 51 includes: an n−1^{th} row of rectangular protrusions 53, 53 each having a length S₁ and a width W₁ which are arranged in the axial direction of the embossing roll 50 (indicated by a solid arrow) at intervals of a distance D₁; an nth row of protrusions 54, 54 each having the same length (S₁) and width (W₁) as those of the protrusions 53 which are arranged in the circumferential direction of the embossing roll 50 (indicated by an outline arrow) at a distance of M₁ from the protrusions 53 so that the longitudinal center line thereof passes through a point of D₁/2; and an n+1^{th} row of protrusions 55, 55 having the same shape as that of the protrusions 53 which are arranged in the same manner as the protrusions 53. The number of protrusions in each row may be determined based on, for example, the number of elastic members to be cutoff. The number of rows of protrusions may be determined based on the length L₁ of the non-adhesive portion. Herein, n is a natural number, and “0 row” means there is no row of protrusions.

In an alternative emboss pattern where n is a natural number equal to or greater than 2, a protrusion in the n−1^{th} row may overlap with the protrusion in the n+1^{th} row in the row direction by at least 1 mm or more. In such a case, a protrusion in the n−1^{th} row may not overlap with the protrusion in the nth row or may overlap with the protrusion in the nth row by about 0.5 mm to about 1 mm. In this way, the density of protrusions in each row may be reduced as compared to the emboss pattern illustrated in FIG. 3A, thereby facilitating the production of the emboss roll.

With an emboss roll having such protrusions as described above, as compared to an emboss roll having a single line blade, the protrusions more easily cut into the combined web, whereby it is possible to easily cut off the elastic member.

FIG. 3B shows a pattern in which diamond-shaped protrusions are arranged in a staggered pattern. The embossing section 51 includes: a row of diamond-shaped protrusions 56, 56 each having a long axis S₂ and a short axis W₂ which are arranged in the axial direction of the embossing roll 50 (indicated by a solid arrow) at intervals of a distance D₂; another row of protrusions 57, 57 each having the same diamond shape as the protrusions 56 which are arranged in the circumferential direction of the embossing roll 50 (indicated by an outline arrow) at a distance of M₂ from the protrusions 56 so that the short axis thereof is collinear with a point of D₂/2; and still another row of protrusions 58, 58 each having the same shape as that of the protrusions 56 which are arranged in the same manner as the protrusions 56. Of course, also for this pattern, the number of protrusions in each row may be determined based on, for example, the number of elastic members to be cut off, and the number of rows of protrusions may be determined based on the length L₁ of the non-adhesive portion.

The length S₁ of the rectangular protrusions and the length of the long axis S₂ of the diamond-shaped protrusions are both preferably in the range of 1 mm to 25 mm, and more preferably 2 mm to 25 mm. Where the interval D₁ between adjacent protrusions is less than or equal to S₁, the elastic member located between adjacent protrusions 53 can be reliably cut off by the protrusion 54 due to the staggered arrangement. Similarly, D₂ and S₂ may be determined so that D₂≦S₂ holds. When S₁ or S₂ is less than 1 mm, the embossing section 51 may fail to cut off the elastic member, and when it is greater than 25 mm, the feel/touch of the article may deteriorate due to the excessive total area of seal portions. D₁ and D₂ are also preferably in the range of 1 mm to 25 mm, and D₁ is more preferably 2 mm to 25 mm. Where diamond-shaped protrusions are used, if a protrusion in a row has little overlap with the closest protrusion in an adjacent row in the row direction, the elastic member may fall between adjacent seal portions, and the embossing section 51 may thereby fail to cut off the elastic member, depending upon the arrangement of the protrusions. In view of this, D₂ is more preferably 3 mm to 10 mm.

When a portion of the combined web is to be melted, the width W₁ of the rectangular protrusions and the length of the short axis W₂ of the diamond-shaped protrusions are preferably 0.5 mm to 15 mm. When the first sheet 10 and the elastic member are cut off, W₁ is preferably several microns to about 0.5 mm. When they are greater than 15 mm, the feel/touch of the manufactured article may deteriorate due to the excessive total area of seal portions. The lower limit of W₂ is preferably 1 mm or more.

While the distance between adjacent rows of protrusions is not limited to any particular value, M₁ or M₂ is preferably 1 mm to 25 mm. The protrusions may have a shape other than a rectangular shape and a diamond shape as described above, including a slanted rectangular shape, a circular shape, a triangular shape, a star shape, a heart shape, a clover shape, a crescent shape, other polygons, etc. The shape of the protrusions maybe varied for different rows.

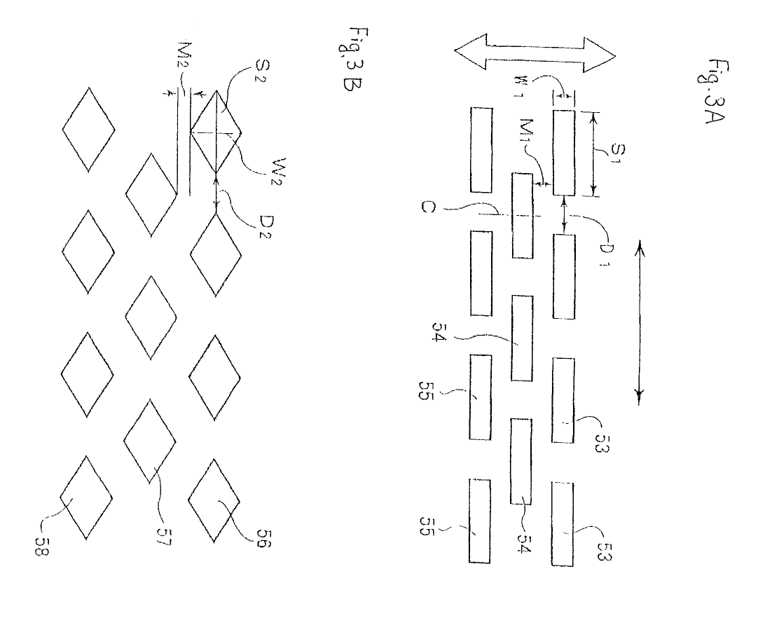

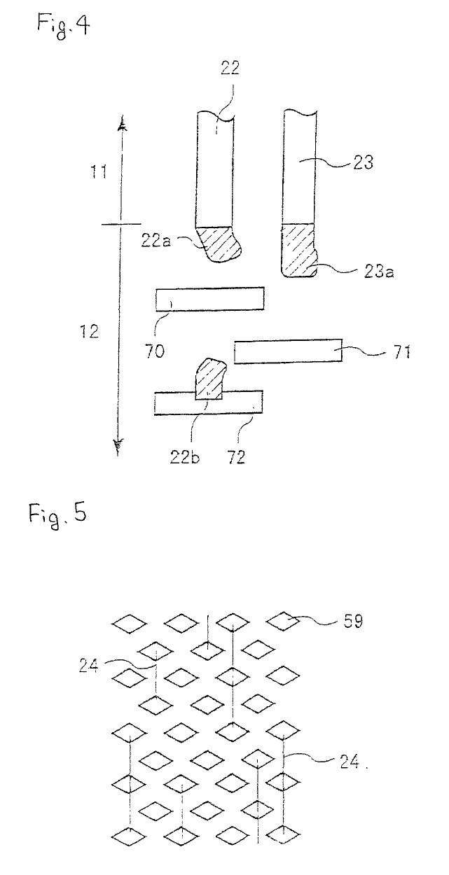

FIG. 4 schematically illustrates elastic members 22 and 23 having been cut off. It is assumed that the combined web is advanced downwardly in FIG. 4. The area 11 is the adhesive portion and the area 12 is the non-adhesive portion. The left-hand side elastic member 22 is cut off by a seal portion 70 (corresponding to the protrusion 53). An end portion 22a of the elastic member 22 is released from the tension and shrink toward the elastic member 22 bonded on the sheet. If the remaining part of the elastic member is caught by the protrusion 55 before completion of the cutting off by the protrusion 53, an elastic member 22b between the protrusion 53 and the protrusion 55 shrinks toward a seal portion 72 when the elastic member is cut off by the protrusion 53. If the cutting off by the protrusion 53 is completed before the remaining part of the elastic member is caught by the protrusion 55, the elastic member 22b will shrink toward the elastic member existing in the downstream adhesive portion (not shown). The right-hand side elastic member 23 is cut off by a seal portion 71 (corresponding to the protrusion 54), and an end portion 23a thereof shrinks.

With the arrangement described above, the elastic member is cut off and a large number of small seal portions are formed in the non-adhesive portion, whereby the upper and lower sheets are bonded together also in the non-adhesive portion. Since the seal portions are separated from one another and each have a small size, they are less likely to give discomfort to the wearer than when they are provided as a continuous line even when they are heat-sealed into a film.

An exemplary adhesive applicator will now be described.

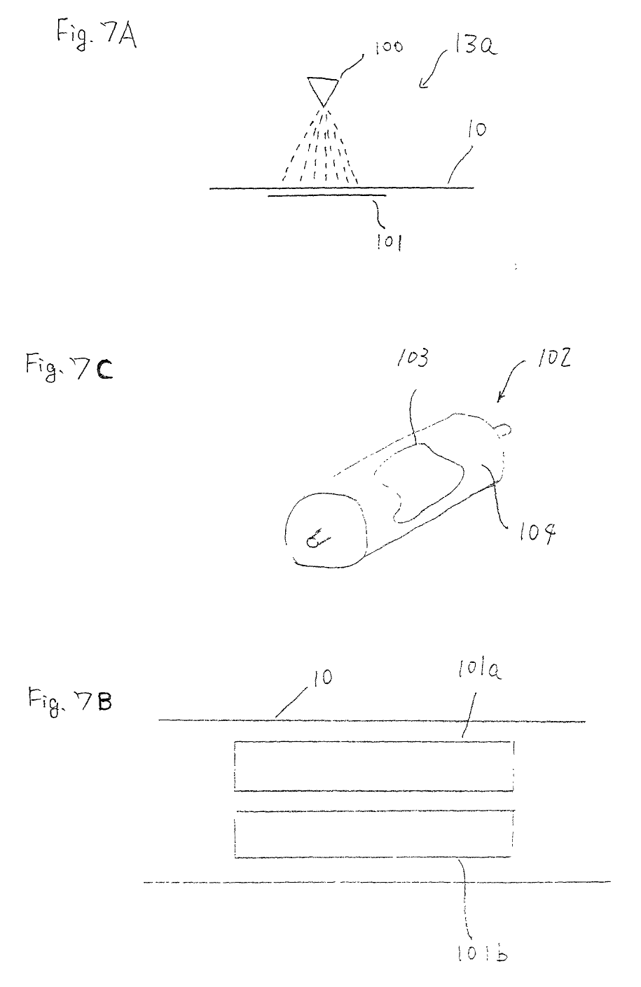

FIG. 7A is a diagram illustrating an exemplary adhesive applicator 13a. The adhesive applicator 13a includes a gun member 100 for spraying an adhesive (a hot melt in the following description) while positively charging the hot melt, and a conductive member 101 which is located under the first sheet 10 and is grounded or negatively charged. Generally, not all of the hot melt sprayed from the gun member 100 is attached to the sheet, but a portion thereof is left floating in the air. However, by charging the hot melt as described above, it is possible to efficiently attach the hot melt to the sheet, and to reduce the amount of hot melt to be scattered with respect to the width direction of the sheet, thereby improving the widthwise precision. A voltage of the same polarity as the hot melt may be applied to portions where it is not necessary to apply the hot melt.

It is possible to improve the positional precision of the attachment of the hot melt in the flow direction, which is transverse to the width direction, by controlling the period in which the hot melt is output and the potential of the gun member 100 or the conductive member 101. The polarities of the applied voltages may be reversed from that described above.

The conductive member 101 may be provided in the form of a plurality of plates 101a and 101b as illustrated in FIG. 7B. For example, when the hot melt is applied on areas separated by a predetermined interval by using a plurality of gun members 100, the hot melt application maybe performed with the interval between adjacent hot melt-applied areas being the interval between the plates 101a and 101b.

Alternatively, the conductive member 101 may be provided in the form of a roller 102 as illustrated in FIG. 7C. The roller 102 rotates in synchronism with the first sheet 10. The roller 102 includes a conductive portion 103 and a non-conductive portion 104. As described above, the hot melt is charged to a potential of the first polarity, and the conductive portion 103 is grounded or charged to a potential of the opposite polarity to the first polarity.

The shape of the conductive portion 103 is determined based on the shape of the area of the first sheet 10 on which the hot melt is to be applied. The gun member 100 is controlled to output the hot melt a predetermined time before the leading edge of the area on which the hot melt is to be applied passes by the gun member 100, and to stop outputting the hot melt a predetermined time before the trailing edge of the area on which the hot melt is to be applied passes by the gun member 100. With such an arrangement, it is possible to attach the hot melt to an area substantially equal to the intended area on which the hot melt should be applied. The roller 102 may be positioned upstream of the gun member 100.

It is understood that the adhesive applicator as described above maybe used for manufacturing articles other than disposable worn articles. Nothing may be sandwiched between the first sheet and second sheet after the application of the hot melt, or a member other than the web materials may be adhered by the hot melt after the application of the hot melt.

The hot melt adhesive may be continuously applied without providing a non-adhesive portion. This may be a more preferred embodiment than when the adhesive portions and the non-adhesive portions are alternately provided, because it is possible, in the former embodiment, to further increase the production line speed. The elastic member may be sandwiched between sheets on which an adhesive has been continuously applied and then passed between the embossing roll and the counter roll, so as to cut off only the elastic member without cutting off the sheets. After the cutting process, each elastic member 24 is held by two (or three or more) seal portions 59 and 59, as illustrated in FIG. 5, while being relaxed. Therefore, even when the coating of the hot melt adhesive is continuous, the seal portion can be made non-elastic by changing the type and/or amount of the hot melt adhesive and/or the spraying direction thereof. It is believed that where the elastic member is cut off by heat, the hot melt adhesive is re-melted and softened by the heat of the embossing roll, so that the anchoring force on the elastic member by the hot melt adhesive is reduced and the elastic recovering force of the elastic member overcomes the anchoring force, whereby the elastic member is bonded to the seal portion while being relaxed.

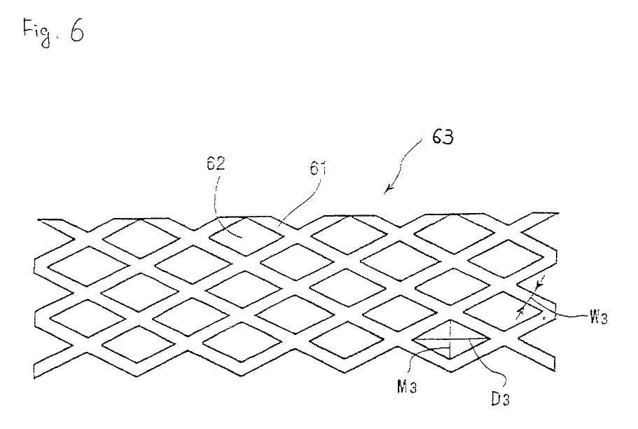

Next, a second embodiment of the present invention will be described. The second embodiment employs, instead of the embossing roll having protrusions spaced apart from one another, an embossing roll including depressions having a length of 1 mm to 25 mm and a width of 0.5 mm to 15 mm and a latticed protrusion (ridges) having a width of 0.5 mm to 5 mm. As illustrated in FIG. 6, the latticed protrusion 63 includes a large number of ridges 61, 61, . . . , which are arranged in the form of parallel crosses, with each space 62 surrounded by the ridges 61 being a depression. W₃ denotes the width of each ridge, which is 0.5 mm to 5 mm. An excessively large width of the ridges may deteriorate the feel/touch of the manufactured article, while the ridges having a width smaller than 0.5 mm may possibly cut off the sheet. D₃ is the length of each depression, which is preferably 5 mm to 25 mm, and more preferably 5 mm to 10 mm. M₃ is the width of each depression, which is preferably 5 mm to 25 mm, and more preferably 5 mm to 10 mm.

While FIG. 6 shows a slanted lattice pattern, the pattern may alternatively be any other polygonal lattice pattern such as a square lattice pattern or a rectangular lattice pattern. In this embodiment, the seal portions are in a lattice pattern, whereby it is possible to reliably cut off the elastic member. Moreover, since the latticed protrusion made up of narrow ridges extends across a sufficiently large area in a meshed pattern, the elastic member can be cut off by any of the seal portions. Where the sealing is provided by using a single line blade, all the elastic members need to be cut off by the single line blade, whereby it is necessary to perform strong sealing so that no elastic member is left uncut. As a result, the sheet may possibly be cut off. With the above-described arrangement, the elastic member can be cut off by any of the seal portions. Therefore, the sheet will not be cut off because it is not necessary to perform strong sealing and the contact surface between the sheet and the protrusion is increased. Moreover, such a latticed seal portion gives the wearer a soft feel/touch, and also is aesthetically desirable. Also in the second embodiment, the sheet may include hot melt adhesive portions and non-adhesive portions, or the hot melt adhesive may be continuously applied on the sheet without providing the non-adhesive portions.

At least one of the embossing roll 50 and the counter roll 60 illustrated in FIG. 1 may include a heating member. Moreover, other heating members such as a rod-shaped sheathed heater, a high-frequency heating member, afar infrared heater, or an oil heater, maybe additionally provided in the vicinity of these rolls. In the arrangement of FIG. 1, the positions of the embossing roll 50 and the counter roll 60 may be reversed.

It is preferred that either the first sheet 10 or the second sheet 30 is heat sealable. Applicable types of sheet include non-woven fabric, a plastic film, knit fabric, woven fabric, paper, etc. Applicable sheet materials include known materials such as a polypropylene, a polyethylene, a polyester, a cellulose, a rayon, etc., which can be used alone or in combination of two or more. Each of the sheets 10 and 30 may be a multi-layer sheet including a number of sheets laminated together. In such a case, a heat sealable sheet should be provided on the uppermost surface of the first sheet 10 or on the lowermost surface of the second sheet 30.

The elastic member may be made of a material that can be cut off by heat (e.g., a thermoplastic polyurethane, an elastomer, a rubber, etc.), and may be provided in the form of a ribbon or a string. A film-shaped elastic member (e.g., an elastomer film) can also be used because it can be reliably cut off by seal portions arranged in a staggered pattern or a lattice pattern. It is preferred that the elastic member has a melting point that is lower than that of the heat sealable material of the second sheet so that the second sheet will not be cut off. The melting point of the second sheet may be higher than that of the first sheet.

While FIG. 1 illustrates an example where the elastic member is adhered in the widthwise central portion of the sheet, the elastic member may alternatively be adhered near the edge of the sheet. In such a case, the emboss pattern can be changed according to the position of the elastic member.

According to the present invention, the seal portions can be made non-elastic after the heat seal process not only in the case where an adhesive is applied so as to provide non-adhesive portions and adhesive portions but also in the case where the adhesive application is continuous. Therefore, an elastic sheet having alternating elastic and non-elastic portions can be continuously manufactured.

What is claimed is:

1. A method for manufacturing a disposable worn article, the method comprising:
a first step of applying an adhesive on at least one of a first web and a second web;
a second step of sandwiching an elastic member between the first and second webs and combining the first and second webs and the elastic member together, thereby producing a combined web; and
a third step of melting a portion of at least one of the first and second webs and a portion of the elastic member, thereby reducing a shrinking force of the elastic member in the melted portion.

2. A method for manufacturing a disposable worn article, the method comprising:
a first step of applying an adhesive on at least one of a first web and a second web;
a second step of sandwiching an elastic member between the first and second webs and combining the first and second webs and the elastic member together, thereby producing a combined web; and
a third step of melting a portion of at least one of the first and second webs and a portion of the elastic member, thereby cutting off the elastic member.

3. A method for manufacturing a disposable worn article, the method comprising:
a first step of applying an adhesive on at least one of a first web and a second web;
a second step of sandwiching an elastic member between the first and second webs and combining the first and second webs and the elastic member together, thereby producing a combined web; and
a third step of cutting off a portion of at least one of the first and second webs, and the elastic member.

4. A method for manufacturing a disposable worn article according to claim 1, wherein:
the third step is performed by passing the combined web between an embossing roll having a plurality of protrusions and a counter roll; and
an interval of the protrusions in a direction of a rotation axis of the embossing roll is about 1 mm to 25 mm.

5. A method for manufacturing a disposable worn article according to claim 2, wherein:
the third step is performed by passing the combined web between an embossing roll having a plurality of protrusions and a counter roll; and
an interval of the protrusions in a direction of a rotation axis of the embossing roll is about 1 mm to 25 mm.

6. A method for manufacturing a disposable worn article according to claim 3, wherein:
the third step is performed by passing the combined web between an embossing roll having a plurality of protrusions and a counter roll; and
an interval of the protrusions in a direction of a rotation axis of the embossing roll is about 1 mm to 25 mm.

7. A method for manufacturing a disposable worn article according to claim 1, wherein the third step is performed by passing the combined web between an embossing roll having a lattice portion and a counter roll.

8. A method for manufacturing a disposable worn article according to claim 2, wherein the third step is performed by passing the combined web between an embossing roll having a lattice portion and a counter roll.

9. A method for manufacturing a disposable worn article according to claim 3, wherein the third step is performed by passing the combined web between an embossing roll having a lattice portion and a counter roll.

10. A method for manufacturing a disposable worn article according to claim 1, wherein a first charge is applied to an area of at least one of the first and second webs where the adhesive is to be applied, and a second charge different from the first charge is applied to the adhesive to be applied.

11. A method for manufacturing a disposable worn article according to claim 2, wherein a first charge is applied to an area of at least one of the first and second webs where the adhesive is to be applied, and a second charge different from the first charge is applied to the adhesive to be applied.

12. A method for manufacturing a disposable worn article according to claim 3, wherein a first charge is applied to an area of at least one of the first and second webs where the adhesive is to be applied, and a second charge different from the first charge is applied to the adhesive to be applied.

13. A method for manufacturing a disposable worn article according to claim 1, wherein:
at least the first web includes a design area having at least one of a graphical design, a symbol and a character printed thereon; and
the elastic member located on at least a portion of the design area is cut off in the third step.

14. A method for manufacturing a disposable worn article according to claim 2, wherein:
at least the first web includes a design area having at least one of a graphical design, a symbol and a character printed thereon; and
the elastic member located on at least a portion of the design area is cut off in the third step.

15. A method for manufacturing a disposable worn article according to claim 1, wherein:
at least the second web includes an area on which a member is to be adhered; and
the elastic member located under at least a portion of the area is cut off in the third step.

16. A method for manufacturing a disposable worn article according to claim 2, wherein:
at least the second web includes an area on which a member is to be adhered; and
the elastic member located under at least a portion of the area is cut off in the third step.

17. A method for manufacturing a disposable worn article according to claim 1, wherein the elastic member is at least one of a string rubber, a flat rubber and a meshed rubber.

18. A method for manufacturing a disposable worn article according to claim 2, wherein the elastic member is at least one of a string rubber, a flat rubber and a meshed rubber.

19. A method for manufacturing a disposable worn article according to claim 3, wherein the elastic member is at least one of a string rubber, a flat rubber and a meshed rubber.
